(19) United States
(12) Patent Application Publication
(10) Pub. No.: US 2020/0070363 A1
(43) Pub. Date: Mar. 5, 2020

(54) Gripper of Bodywork Parts

(71) Applicant: COMPAGNIE PLASTIC OMNIUM, Lyon (FR)

(72) Inventor: David TRESSE, Sainte-Julie (FR)

(21) Appl. No.: 16/556,771

(22) Filed: Aug. 30, 2019

(30) Foreign Application Priority Data
Aug. 30, 2018 (FR) 1857808

(51) Int. Cl. B25J 15/06; B25J 15/00

(52) U.S. Cl. CPC B25J 15/0616; B25J 15/0052

(57) ABSTRACT

The present disclosure relates to a gripper of motor vehicle bodywork parts. The gripper may include a main body and plastic extensions extending from the main body. The plastic extensions may be configured to grip a bodywork part. Each extension may include a main portion and means for connection the main portion to at least one sucker of an air suction device. The main portion and the connection means may be made in one piece.

### TECHNICAL FIELD

The present disclosure relates to grippers of motor vehicle bodywork parts.

### BACKGROUND

These grippers are used in the automotive industry to pick up (using suckers for example) and handle the bodywork parts for various purposes. For example, positioning and orienting bodywork parts in front of fixed measuring instruments for quality control of the parts before delivering them to a customer.

During these controls, the measuring instruments measure parameters relating to the correct operation of devices assembled on the bodywork parts. For example, a bumper equipped with distance sensors or a defrosting device.

Grippers made entirely of metal are known. However, the presence of metal portions in the areas near the bodywork parts (which is inevitable since the gripper grips the bodywork part) may pose problems regarding the measurements taken during quality controls. These metal portions may for example create magnetic or electromagnetic interference during the operation of the devices mounted near or on the bodywork parts. For example, it may be necessary to test the behaviour of the waves, in transmission or in reflection, near the bodywork parts in question. As an example, such waves may be waves whose frequency ranges from 3 up to 300 GHz, from 100 up to 384 THz or even from 384 to 789 THz.

In addition, some tests, for example the defrosting device tests, may cause local heating of the grippers near the bodywork parts and at the areas of contact with the bodywork parts. This heating may bias the thermal behaviour of the parts to be tested (for example by radiation or conduction from the heated areas of the grippers), resulting in incorrect performance during the tests of these devices. This heating may also result in the appearance of local deformations, which may pose problems for a gripper whose above-mentioned areas are composed of several parts connected to each other. Gripping by suckers for example is possible by creating a vacuum via a connection between said suckers and an air suction device. In the event of deformation of the connection means, a loss of tightness of the vacuum creation system may impair the gripping of the bodywork parts or even lead to a total loss of the gripping ability.

### SUMMARY

The present disclosure aims to remedy these disadvantages by providing a gripper of motor vehicle bodywork parts enabling optimum quality control of the parts while ensuring correct operation of the gripper during repeated use.

The present disclosure therefore relates to a gripper of motor vehicle bodywork parts, comprising:

a main body, and

plastic extensions extending from the main body and used to grip a bodywork part, each extension comprising a main portion and means for connecting the main portion to at least one sucker and to an air suction device, the main portion and the connection means being made in one piece.

Thus, we obtain a gripper whose areas in the immediate proximity of a bodywork part and in contact with the latter are made of plastic and therefore much less disturbing than the metal portions of the prior art as regards the quality of the measurements taken during the various quality controls. In addition, the various means for connecting the extensions to the suckers and to the air suction device are made in one piece with the main portion of the extensions, which limits the number of connections and parts present near the bodywork parts and therefore limits, in case of heating, the risks of causing sealing defects at the air suction system used to grip the bodywork parts.

The gripper according to the present disclosure may further comprise at least one of the following characteristics:
the extensions are made by additive synthesis;
the extensions extend in different directions from one another;
the main body comprises a main tube and secondary tubes, the secondary tubes comprising removable means for attaching the extensions; and
the secondary tubes comprise grooves designed to cooperate with attachment ends present on the extensions.

### BRIEF DESCRIPTION OF THE DRAWINGS

We will now describe embodiments of the present disclosure, given as non-limiting examples referring to the attached figures.

FIG. 1 is a perspective view of a gripper according to the present disclosure;

FIG. 2 is a perspective view of the gripper of FIG. 1 on which a front bumper is placed;

FIG. 3 is an enlargement of the gripper of FIG. 2 showing the extensions of the gripper;

FIG. 4 is a perspective view of an extension according to the present disclosure; and

FIG. 5 is a cross-sectional view of an extension according to the present disclosure.

### DETAILED DESCRIPTION

We now refer to FIG. 1 which shows a gripper 2 of motor vehicle bodywork parts. It comprises a main body 4 composed of several bars for example several straight metal tubes. In the example shown, the main body 4 is composed of a main tube 6 and two secondary tubes 8 perpendicular to the main tube 6 and extending from the ends of the latter in two opposite directions from these ends. The main tube 6 comprises means 10 for connecting the gripper 2 to a device used to handle it, for example a robot-controlled arm.

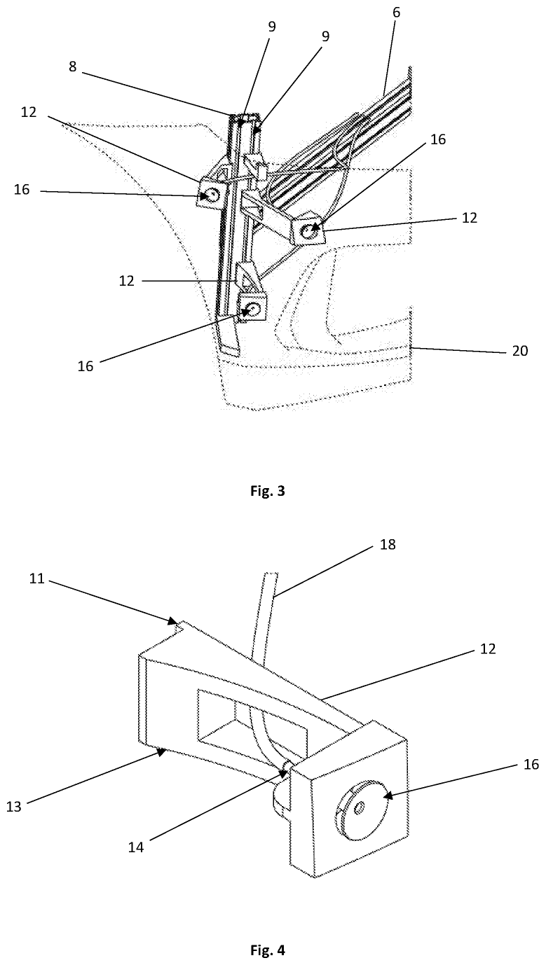

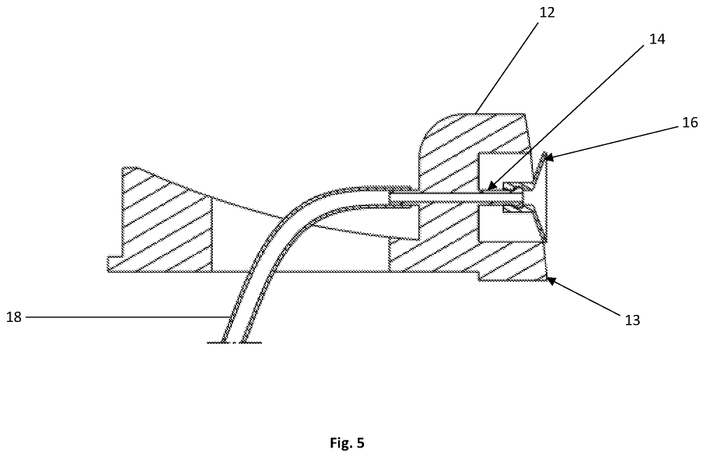

Each of the secondary tubes 8 is equipped with at least one plastic extension 12, preferably made by additive synthesis (generally called “3D printing”). The secondary tubes 8 may for example comprise grooves 9, as shown on FIG. 3, into which attachment ends 11 present on the extensions and complementary to the grooves 9 are inserted, for example by sliding them inside the grooves 9. Other types of attachment, for example by clipping, may be considered. A removable attachment is used to adapt the gripper 2 to the geometry of the bodywork part to be gripped and moved.

Each of the extensions 12 comprises a main portion 13 and means 14 for connecting to at least one sucker 16 and one air suction device 18 of the gripper 2. Each connection means 14 therefore forms a sucker support and a means for connecting the sucker to a suction tube itself connected to an air suction means used to suck out the air present between the suckers 16 and a bodywork part in contact with the suckers and consequently to grip said bodywork part. The connection means 14 are made in one piece with the main portion 13 of the extensions 12, additive synthesis simplifying the manufacture of these parts.

As shown on FIGS. 1 to 3, all the suction tubes connected to the various suckers 16 by the connection means 14 are grouped at the main tube 6 and then converge towards the air suction means such as for example a vacuum pump (not shown). The suction tubes can be connected to the suction means at the connections means 10.

The main portion 13 of the extensions 12 may further comprise a recess to feed a suction tube.

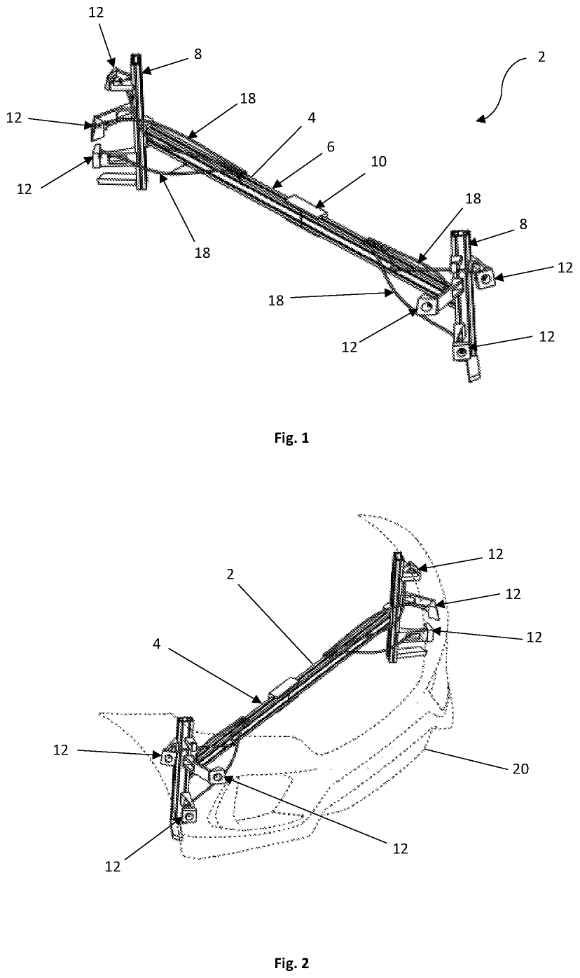

The extensions 12 may extend, as shown on FIGS. 1 and 2, in different directions from one another in order to grip bodywork parts at their curved areas. This can be seen on FIG. 2 showing a front bumper 20 in dotted lines. The extensions 12 extend in different directions in order to grip the front bumper 20 at its lateral returns.

The invention is not limited to the embodiments described and other embodiments will be clearly apparent to those skilled in the art. In particular, the shape of the main body of the gripper or the number, shape and arrangement of the extensions can be modified.

### LIST OF NUMERICAL REFERENCES

2: gripper
4: main body
6: main tube
8: secondary tubes
9: grooves
10: connection means
11: attachment ends
12: extensions
13: main portion of the ends
14: connection means
16: suckers
18: air suction device
20: front bumper

1. A gripper of motor vehicle bodywork parts comprising:
a main body, and
plastic extensions extending from the main body and configured to grip a bodywork part, each extension comprising a main portion and means for connecting the main portion to at least one sucker and to an air suction device, the main portion and the connection means being made in one piece.

2. The gripper according to claim 1, wherein the extensions are made by additive synthesis.

3. The gripper according to claim 1, wherein the extensions extend in different directions from one another.

4. The gripper according to claim 1, wherein the main body comprises a main tube and secondary tubes, the secondary tubes comprising removable means for attaching the extensions.

5. The gripper according to claim 4, wherein the secondary tubes comprise grooves designed to cooperate with attachment ends present on the extensions.

6. The gripper according to claim 2, wherein the extensions extend in different directions from one another.

7. The gripper according to claim 2, wherein the main body comprises a main tube and secondary tubes, the secondary tubes comprising removable means for attaching the extensions.

8. The gripper according to claim 3, wherein the main body comprises a main tube and secondary tubes, the secondary tubes comprising removable means for attaching the extensions.

9. A gripper configured to grip a front bumper, the gripper comprising:
a main body, comprising a main tube and two secondary tubes, each of the two secondary tubes attached to an end of the main tube;
one or more extensions extending from the secondary tubes, each extension comprising at least one sucker configured to grip the front bumper; and
an air suction device configured to provide air suction to the at least one sucker.

10. The gripper according to claim 9, wherein each of the extensions comprises a main portion and a secondary portion connecting the main portion to the at least one sucker.

11. The gripper according to claim 9, wherein the air suction device comprises one or more suction tubes configured to connect the suckers to an air suction source.

12. The gripper according to claim 9, wherein at least one of the extensions extends from a first of the secondary tubes and at least one of the extensions extends from a second of the secondary tubes.

13. The gripper according to claim 9, wherein the secondary tubes are perpendicular to the main tube and the extensions are parallel to the main tube.

14. The gripper according to claim 9, wherein the main body is configured to connect to a gripper.

15. The gripper of claim 9, wherein the gripper is configured to grip one or more curved portions of the front bumper.

16. The gripper according to claim 9, wherein each of the secondary tubes comprises one or more grooves and each of the extensions comprises an attachment end configured to attach to the one or more grooves.
